(19) United States
(12) Patent Application Publication
(10) Pub. No.: US 2026/0309677 A1
(43) Pub. Date: Oct. 8, 2026

(54) ULTRASOUND SYSTEM AND CONTROL METHOD OF ULTRASOUND SYSTEM

(71) Applicant: FUJIFILM Corporation, Tokyo (JP)

(72) Inventor: Rika TASHIRO, Kanagawa (JP)

(73) Assignee: FUJIFILM Corporation, Tokyo (JP)

(21) Appl. No.: 19/570,164

(22) Filed: Mar. 18, 2026

(30) Foreign Application Priority Data
Apr. 7, 2025 (JP) 2025-062917

(51) Int. Cl. G01N 29/24; G01N 29/22; H01M 10/44; H01M 10/48; H02J 50/10

(52) U.S. Cl. CPC G01N 29/2481; G01N 29/223; H01M 10/44; H01M 10/488; H02J 50/10

(57) ABSTRACT

Provided are an ultrasound system and a control method of the ultrasound system that can efficiently use a terminal-side battery of a mobile information terminal and a probe-side battery of an ultrasound probe.

An ultrasound system includes a mobile information terminal that includes a monitor and incorporates a terminal-side battery, an ultrasound probe that is connected to the mobile information terminal and that incorporates a probe-side battery, and a probe charger that charges the probe-side battery with power supplied from the terminal-side battery, in which the mobile information terminal includes a charging controller that controls the charging of the probe-side battery by the probe charger based on a remaining amount of the terminal-side battery.

### CROSS-REFERENCE TO RELATED APPLICATIONS

The present application claims priority under 35 U.S.C. § 119 to Japanese Patent Application No. 2025-062917, filed on Apr. 7, 2025. Each of the above application(s) is hereby expressly incorporated by reference, in its entirety, into the present application.

### BACKGROUND OF THE INVENTION

### 1. Field of the Invention

The present invention relates to an ultrasound system comprising an ultrasound probe incorporating a battery and a control method of the ultrasound system.

### 2. Description of the Related Art

In the related art, an ultrasound examination has been performed in which an ultrasound image representing a tomographic plane in a subject is captured using a so-called ultrasound system, and the inside of the subject is examined based on the captured ultrasound image. In order to smoothly perform such an ultrasound examination, for example, as disclosed in JP2021-129811A, an ultrasound system comprising an ultrasound probe incorporating a battery and a mobile information terminal such as a so-called tablet connected to the ultrasound probe by so-called wireless communication has been developed. The battery of the ultrasound probe in JP2021-129811A is charged by surplus power of the mobile information terminal or so-called wireless power supply.

### SUMMARY OF THE INVENTION

However, in the technique of JP2021-129811A, the remaining amount of the battery of the mobile information terminal may be insufficient due to a large power supply amount to be supplied from the mobile information terminal to the ultrasound probe. In this case, the use of the ultrasound system may have to be stopped even though the remaining amount of the battery of the ultrasound probe is sufficient.

The present invention has been made in order to solve such a problem in the related art, and an object of the present invention is to provide an ultrasound system and a control method of the ultrasound system capable of efficiently using a terminal-side battery of a mobile information terminal and a probe-side battery of an ultrasound probe.

The above-described object can be achieved with the following configurations.
[1] An ultrasound system comprising:
a mobile information terminal that includes a monitor and incorporates a terminal-side battery;
an ultrasound probe that is connected to the mobile information terminal and that incorporates a probe-side battery; and
a probe charger that charges the probe-side battery with power supplied from the terminal-side battery,
in which the mobile information terminal includes a charging controller that controls the charging of the probe-side battery by the probe charger based on a remaining amount of the terminal-side battery.
[2] The ultrasound system according to [1],
in which the mobile information terminal includes
   a terminal-side period calculation unit that calculates a drivable period of the mobile information terminal by the terminal-side battery based on the remaining amount of the terminal-side battery, and
   a probe-side period calculation unit that calculates a drivable period of the ultrasound probe by the probe-side battery based on a remaining amount of the probe-side battery, and
the charging controller performs the charging of the probe-side battery by the probe charger until a difference between the drivable period of the mobile information terminal calculated by the terminal-side period calculation unit and the drivable period of the ultrasound probe calculated by the probe-side period calculation unit is equal to or less than a determined threshold value.
[3] The ultrasound system according to [1],
in which the mobile information terminal includes
   a maximum power supply amount calculation unit that calculates a maximum power supply amount to be supplied from the terminal-side battery to the probe-side battery, based on the remaining amount of the terminal-side battery, and
   a scheduled power supply amount setting unit that sets a scheduled power supply amount to be supplied from the terminal-side battery to the probe-side battery in a range up to the maximum power supply amount calculated by the maximum power supply amount calculation unit, and
the charging controller performs the charging of the probe-side battery by the probe charger until the power supply amount is equal to or greater than the scheduled power supply amount set by the scheduled power supply amount setting unit.
[4] The ultrasound system according to any one of [1] to [3], further comprising:
a probe holder that holds the ultrasound probe and in which the probe charger is disposed.
[5] The ultrasound system according to [4],
in which the probe holder includes a holder light emitting unit, and causes the holder light emitting unit to emit light according to at least one of the remaining amount of the terminal-side battery or a remaining amount of the probe-side battery.
[6] The ultrasound system according to [5],
in which the holder light emitting unit is composed of a light emitting diode, and causes the light emitting diode to emit light by changing a color according to at least one of the remaining amount of the terminal-side battery or the remaining amount of the probe-side battery.
[7] The ultrasound system according to [5],
in which the holder light emitting unit is composed of a light emitting diode for a terminal and a light emitting diode for a probe, and
the probe holder causes the light emitting diode for a terminal and the light emitting diode for a probe to emit light by changing a color according to the remaining amount of the terminal-side battery and the remaining amount of the probe-side battery.
[8] The ultrasound system according to any one of [5] to [7],
in which the probe holder causes the holder light emitting unit to emit light in a case where the remaining amount of the terminal-side battery is equal to or less than a determined threshold value.
[9] The ultrasound system according to [8],
in which the mobile information terminal
   includes preset information related to at least one of an examination site of a subject, a type of an examination, information on the subject, or information on a user, and
   determines a timing at which the holder light emitting unit emits light, based on the preset information.
[10] The ultrasound system according to any one of [1] to [7],
in which the mobile information terminal notifies a user in a case where the remaining amount of the terminal-side battery is equal to or less than a determined threshold value.

[11] The ultrasound system according to [10],
in which the mobile information terminal
   notifies the user by displaying on the monitor, and
   sets a display size of the notification on the monitor during an examination to be larger than a display size of the notification on the monitor during an examination stop.
[12] The ultrasound system according to or [11],
in which the mobile information terminal
   includes preset information related to at least one of an examination site of a subject, a type of an examination, information on the subject, or information on the user, and
   determines a timing of notifying the user, based on the preset information.
[13] The ultrasound system according to any one of [1] to [12],
in which the mobile information terminal displays, on the monitor, both the remaining amount of the terminal-side battery and a remaining amount of the probe-side battery.
[14] The ultrasound system according to [13],
in which the mobile information terminal further displays, on the monitor, a wireless connection state between the ultrasound probe and the mobile information terminal.
[15] The ultrasound system according to or [14],
in which the mobile information terminal displays, on the monitor, both the remaining amount of the terminal-side battery and the remaining amount of the probe-side battery at any of an end of an examination, a start of the examination, or recovery from sleep.
[16] The ultrasound system according to or [14],
in which the mobile information terminal displays, on the monitor, both the remaining amount of the terminal-side battery and the remaining amount of the probe-side battery at each of an end of an examination, a start of the examination, and recovery from sleep.
[17] The ultrasound system according to [5],
in which the ultrasound probe includes a probe light emitting unit, and
in a case where the ultrasound probe is held by the probe holder, the probe holder stops the light emission by the holder light emitting unit and causes the probe light emitting unit to emit light.
[18] A control method of an ultrasound system including a mobile information terminal that incorporates a terminal-side battery, an ultrasound probe that incorporates a probe-side battery, and a probe charger that charges the probe-side battery with power supplied from the terminal-side battery, the control method comprising:
controlling the charging of the probe-side battery by the probe charger based on a remaining amount of the terminal-side battery.

In the present invention, the ultrasound system comprises the mobile information terminal that includes the monitor and incorporates the terminal-side battery, the ultrasound probe that is connected to the mobile information terminal and that incorporates the probe-side battery, and the probe charger that charges the probe-side battery with the power supplied from the terminal-side battery, and the mobile information terminal includes the charging controller that controls the charging of the probe-side battery by the probe charger based on the remaining amount of the terminal-side battery. Therefore, the terminal-side battery of the mobile information terminal and the probe-side battery of the ultrasound probe can be efficiently used.

### BRIEF DESCRIPTION OF THE DRAWINGS

FIG. 1 is a block diagram showing a configuration of an ultrasound system according to Embodiment 1 of the present invention.

FIG. 2 is a block diagram showing an internal configuration of an ultrasound probe and an internal configuration of a mobile information terminal in Embodiment 1 of the present invention.

FIG. 3 is a block diagram showing an internal configuration of a transmission and reception circuit in Embodiment 1 of the present invention.

FIG. 4 is a block diagram showing an internal configuration of an image generation unit in Embodiment 1 of the present invention.

FIG. 5 is an enlarged view showing a probe holder in Embodiment 1 of the present invention.

FIG. 6 is a diagram showing a first example of a holder light emitting unit of the probe holder in Embodiment 1 of the present invention.

FIG. 7 is a diagram showing a second example of the holder light emitting unit of the probe holder in Embodiment 1 of the present invention.

FIG. 8 is a diagram showing a first example of a notification displayed on a monitor of the mobile information terminal in Embodiment 1 of the present invention.

FIG. 9 is a diagram showing a second example of the notification displayed on the monitor of the mobile information terminal in Embodiment 1 of the present invention.

FIG. 10 is a diagram showing an example of a probe light emitting unit of the ultrasound probe in Embodiment 1 of the present invention.

FIG. 11 is a block diagram showing an internal configuration of an ultrasound probe and an internal configuration of a mobile information terminal in Embodiment 2 of the present invention.

FIG. 12 is a diagram showing an example of a slider displayed on a monitor to set a scheduled power supply amount to be supplied from a terminal-side battery of the mobile information terminal to a probe-side battery of the ultrasound probe.

### DESCRIPTION OF THE PREFERRED EMBODIMENTS

Hereinafter, an embodiment of the present invention will be described with reference to the accompanying drawings.

Description of configuration requirements written below is provided based on a representative embodiment of the present invention, but the present invention is not limited to such an embodiment.

In the present specification, numerical ranges represented using “to” mean a range including numerical values before and after “to” as lower limit values and upper limit values.

In the present specification, “same” and “identical” include an error range which is generally allowed in the technical field.

### Embodiment 1

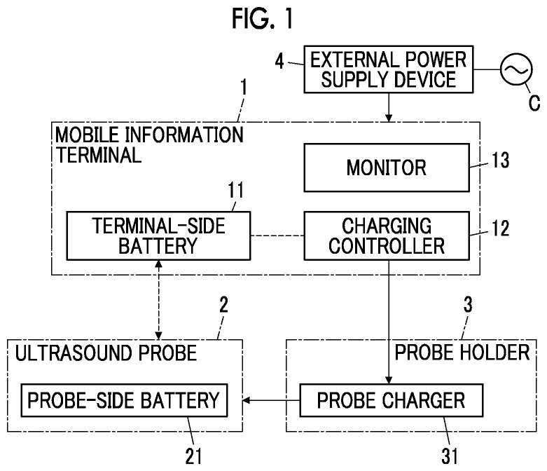

FIG. 1 shows a configuration of an ultrasound system according to Embodiment 1 of the present invention. The ultrasound system comprises a mobile information terminal 1, an ultrasound probe 2 that is wirelessly connected to the mobile information terminal 1, a probe holder 3 that holds the ultrasound probe 2 and is connected to the mobile information terminal 1, and an external power supply device 4 that is connected to the mobile information terminal 1. The external power supply device 4 is configured by a so-called alternating current (AC) adapter or the like, and is connected to an AC power supply C having a specified voltage value.

The ultrasound probe 2 is wirelessly connected to the mobile information terminal 1 and transmits and receives ultrasound waves to and from the inside of a subject to capture an ultrasound image. The ultrasound probe 2 incorporates a probe-side battery 21. The probe-side battery 21 is charged by being supplied with power from the probe holder 3. Various batteries can be used as the probe-side battery 21, and for example, a so-called lithium ion battery can be used. The internal configuration of the ultrasound probe 2 will be described in detail below.

The probe holder 3 includes a probe charger 31. The probe charger 31 charges the probe-side battery 21 of the ultrasound probe 2 by being supplied with power from the mobile information terminal 1.

The mobile information terminal 1 is a handheld type information terminal called a so-called tablet or smartphone, and includes a terminal-side battery 11, a charging controller 12 connected to the terminal-side battery 11, and a monitor 13.

The mobile information terminal 1 is driven by power supplied from the terminal-side battery 11. The terminal-side battery 11 is charged by an external power supply device 4 connected to the AC power supply C, and supplies power to the probe charger 31 of the probe holder 3. As the terminal-side battery 11, various batteries can be used, but for example, a so-called lithium ion battery can be used.

The charging controller 12 controls the charging of the probe-side battery 21 by the probe charger 31 of the probe holder 3 based on the remaining amount of the terminal-side battery 11. For example, as the remaining amount of the terminal-side battery 11 is smaller than the remaining amount of the probe-side battery 21, the power supply amount to be supplied from the terminal-side battery 11 to the probe-side battery 21 via the probe charger 31 is larger, and thus the use of the ultrasound system may have to be stopped even though the remaining amount of the probe-side battery 21 is sufficient. The charging controller 12 can control the probe charger 31 to charge the probe-side battery 21 by the probe charger 31 until, for example, a difference between a drivable period of the ultrasound probe 2 and a drivable period of the mobile information terminal 1 is equal to or less than a determined threshold value.

As a result, for example, the ultrasound system can efficiently use the probe-side battery 21 and the terminal-side battery 11 such that the drivable periods of the ultrasound probe 2 and the mobile information terminal 1 are substantially the same.

Next, the internal configurations of the ultrasound probe 2 and the mobile information terminal 1 will be described in detail. As an example, the wireless power supply to the ultrasound probe 2 from the probe charger 31 of the probe holder 3 by a so-called electromagnetic induction method will be described. In this case, the probe charger 31 includes a power transmitting coil described later and transmits a search signal for searching for a power receiving coil of the ultrasound probe 2 described later to the ultrasound probe 2. The probe charger 31 detects that the ultrasound probe 2 is at a position where the ultrasound probe 2 can be charged by the probe charger 31 by receiving a response signal from the power receiving coil that has received the search signal.

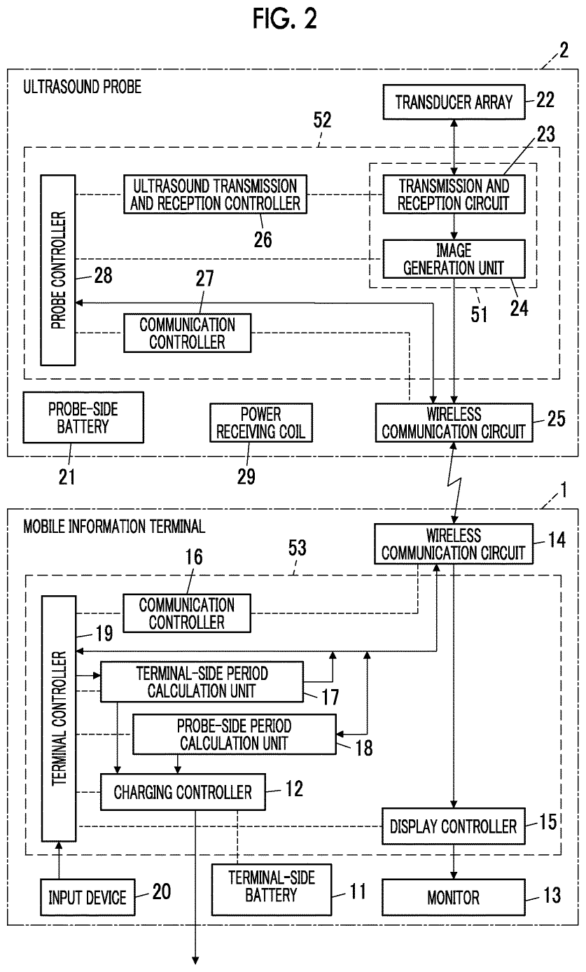

FIG. 2 shows an example of the internal configurations of the ultrasound probe 2 and the mobile information terminal 1. The ultrasound probe 2 includes a transducer array 22, and a transmission and reception circuit 23, an image generation unit 24, and a wireless communication circuit 25 are sequentially connected to the transducer array 22. In addition, an ultrasound transmission and reception controller 26 is connected to the transmission and reception circuit 23. A communication controller 27 is connected to the wireless communication circuit 25. A probe controller 28 is connected to the image generation unit 24, the wireless communication circuit 25, the ultrasound transmission and reception controller 26, and the communication controller 27. In addition, the ultrasound probe 2 includes a power receiving coil 29.

The transmission and reception circuit 23 and the image generation unit 24 constitute an image acquisition unit 51. In addition, a probe processor 52 for the ultrasound probe 2 is configured by the transmission and reception circuit 23, the image generation unit 24, the ultrasound transmission and reception controller 26, the communication controller 27, and the probe controller 28.

The mobile information terminal 1 includes a wireless communication circuit 14, and a display controller 15 and a monitor 13 are sequentially connected to the wireless communication circuit 14. A communication controller 16, a terminal-side period calculation unit 17, and a probe-side period calculation unit 18 are connected to the wireless communication circuit 14. A charging controller 12 is connected to the terminal-side period calculation unit 17 and the probe-side period calculation unit 18. A terminal-side battery 11 is connected to the charging controller 12. In addition, a terminal controller 19 is connected to the charging controller 12, the wireless communication circuit 14, the display controller 15, the communication controller 16, the terminal-side period calculation unit 17, and the probe-side period calculation unit 18. An input device 20 is connected to the terminal controller 19.

A terminal processor 53 for the mobile information terminal 1 is configured by the charging controller 12, the display controller 15, the communication controller 16, the terminal-side period calculation unit 17, the probe-side period calculation unit 18, and the terminal controller 19.

The transducer array 22 of the ultrasound probe 2 has a plurality of ultrasound oscillators that are one-dimensionally or two-dimensionally arranged. In accordance with a drive signal supplied from the transmission and reception circuit 23, each of the ultrasound oscillators transmits ultrasound wave and receives an ultrasound echo from a subject to output a signal based on the ultrasound echo. Each ultrasound oscillator is configured by forming an electrode at both ends of a piezoelectric body consisting of, for example, a piezoelectric ceramic represented by lead zirconate titanate (PZT), a polymer piezoelectric element represented by polyvinylidene difluoride (PVDF), and a piezoelectric single crystal represented by a lead magnesium niobate-lead titanate (PMN-PT).

The image acquisition unit 51 configured by the transmission and reception circuit 23 and the image generation unit 24 acquires an ultrasound image in which a tomographic plane inside the subject is captured by transmitting and receiving an ultrasound beam using the ultrasound probe 2.

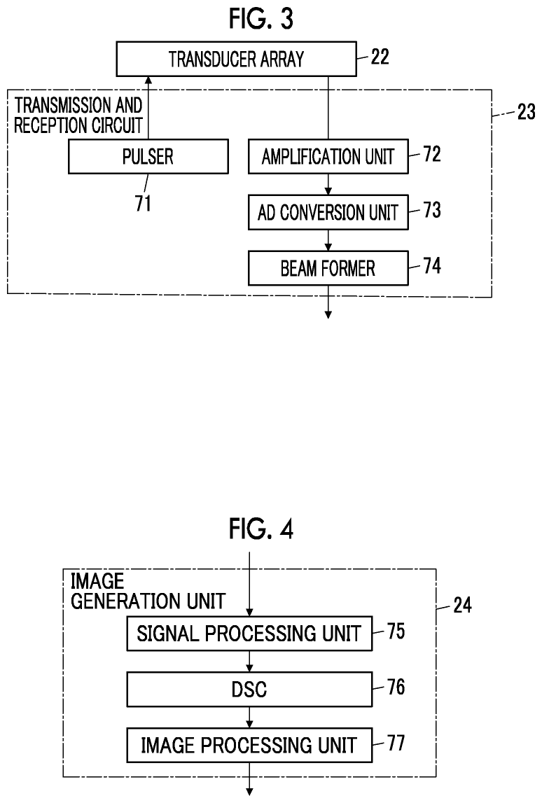

The transmission and reception circuit 23 causes the transducer array 22 to transmit the ultrasound wave and generates a sound ray signal based on a reception signal acquired by the transducer array 22, under the control of the probe controller 28. As shown in FIG. 3, the transmission and reception circuit 23 includes a pulser 71 connected to the transducer array 22, and an amplification unit 72, an analog-to-digital (AD) conversion unit 73, and a beam former 74 that are sequentially connected in series to the transducer array 22.

The pulser 71 includes, for example, a plurality of pulse generators, and supplies each drive signal to the plurality of ultrasound oscillators of the transducer array 22 such that the ultrasound waves transmitted from the plurality of ultrasound oscillators form an ultrasound beam, by adjusting a delay amount based on a transmission delay pattern selected in response to a control signal from the ultrasound transmission and reception controller 26 and the probe controller 28. In this way, in a case where a pulsed or continuous wave-like voltage is applied to the electrodes of the ultrasound oscillator of the transducer array 22, the piezoelectric body expands and contracts to generate a pulsed or continuous wave-like ultrasound wave from each of the ultrasound oscillators, thereby forming an ultrasound beam from the combined wave of these ultrasound waves.

The transmitted ultrasound beam is reflected in a target, for example, a site of the subject, and propagates toward the transducer array 22 of the ultrasound probe 2. The ultrasound echo propagating toward the transducer array 22 is received by each ultrasound oscillator constituting the transducer array 22. In this case, each of the ultrasound oscillators constituting the transducer array 22 receives the propagating ultrasound echo to expand and contract to generate the reception signal, which is an electrical signal, and outputs these reception signals to the amplification unit 72.

The amplification unit 72 amplifies the signal input from each of the ultrasound oscillators constituting the transducer array 22 and transmits the amplified signal to the AD conversion unit 73. The AD conversion unit 73 converts the signal transmitted from the amplification unit 72 into digital reception data. The beam former 74 performs so-called reception focus processing by applying and adding the delay to each reception data received from the AD conversion unit 73. By this reception focus processing, each reception data converted by the AD conversion unit 73 is phase-added, and the sound ray signal in which the focus of the ultrasound echo is narrowed down is acquired.

As shown in FIG. 4, the image generation unit 24 has a configuration in which a signal processing unit 75, a digital scan converter (DSC) 76, and an image processing unit 77 are sequentially connected in series.

The signal processing unit 75 generates a B-mode image signal, which is tomographic image information regarding tissues inside the subject, by performing, on the sound ray signal received from the transmission and reception circuit 23, correction of the attenuation due to the distance according to the depth of the reflection position of the ultrasound wave using a sound velocity value set by the probe controller 28 and then performing envelope detection processing.

The DSC 76 converts (raster-converts) the B-mode image signal generated by the signal processing unit 75 into an image signal in accordance with a normal television signal scanning method.

The image processing unit 77 performs various necessary image processing such as gradation processing on the B-mode image signal input from the DSC 76, and then transmits the B-mode image signal to the wireless communication circuit 25. Hereinafter, the B-mode image signal that has been subjected to image processing by the image processing unit 77 is referred to as an ultrasound image.

The ultrasound transmission and reception controller 26 controls the transmission and reception circuit 23 to transmit and receive the ultrasound waves according to transmission and reception conditions determined in the transducer array 22. The determined transmission and reception conditions may include, for example, a transmission pattern of the ultrasound waves, a transmission focus position of the ultrasound waves, a reception focus position, a display depth of the ultrasound image, and conditions of a gain and a dynamic range of the reception signal.

The wireless communication circuit 25 is a circuit that wirelessly transmits the ultrasound image acquired by the image acquisition unit 51 and information indicating a remaining amount of the probe-side battery 21 to the mobile information terminal 1, and transmits and receives other necessary information to and from the mobile information terminal 1 by wireless communication. The information indicating the remaining amount of the probe-side battery 21 is acquired by, for example, the probe controller 28.

The communication controller 27 controls the transmission and reception of the information with the mobile information terminal 1 by the wireless communication circuit 25. The communication controller 27 can cause the wireless communication circuit 25 to transmit and receive, for example, information for the ultrasound probe 2 to wirelessly connect to the mobile information terminal 1, transmit the ultrasound image to the mobile information terminal 1, and the like.

The power receiving coil 29 receives the power supplied from the probe charger 31 by sensing a magnetic field emitted from the probe charger 31 of the probe holder 3. In addition, the power receiving coil 29 emits a response signal in response to a search signal transmitted from the probe charger 31.

The wireless communication circuit 14 of the mobile information terminal 1 receives the ultrasound image, the information indicating the remaining amount of the probe-side battery 21, and the like from the ultrasound probe 2 by wireless communication.

The communication controller 16 controls the transmission and reception of information to and from the ultrasound probe 2 via the wireless communication circuit 14. The communication controller 16 can cause the wireless communication circuit 14 to transmit and receive, for example, information for the ultrasound probe 2 to wirelessly connect to the mobile information terminal 1, receive the ultrasound image from the ultrasound probe 2, and the like.

The terminal-side period calculation unit 17 receives, for example, information indicating the remaining amount of the terminal-side battery 11 from the terminal controller 19, and calculates the drivable period of the mobile information terminal 1 by the terminal-side battery 11 based on the remaining amount of the terminal-side battery 11. The terminal-side period calculation unit 17 can calculate the drivable period of the mobile information terminal 1 by, for example, storing in advance the average power consumption per determined time, such as one hour, of the mobile information terminal 1 and dividing the remaining amount of the terminal-side battery 11 by the average power consumption.

The probe-side period calculation unit 18 calculates the drivable period of the ultrasound probe 2 by the probe-side battery 21 based on the remaining amount of the probe-side battery 21. The probe-side period calculation unit 18 can calculate the drivable period of the ultrasound probe 2 by, for example, storing in advance the average power consumption per determined time, such as one hour, of the ultrasound probe 2 and dividing the remaining amount of the probe-side battery 21 received from the ultrasound probe 2 via the wireless communication circuit 14 by the average power consumption.

The charging controller 12 controls the probe charger 31 to charge the probe-side battery 21 by the probe charger 31 of the probe holder 3 until the difference between the drivable period of the mobile information terminal 1 calculated by the terminal-side period calculation unit 17 and the drivable period of the ultrasound probe 2 calculated by the probe-side period calculation unit 18 is equal to or less than a determined threshold value. As a result, for example, the ultrasound system can efficiently use the probe-side battery 21 and the terminal-side battery 11 such that the drivable periods of the ultrasound probe 2 and the mobile information terminal 1 are substantially the same.

The input device 20 is for a user to perform an input operation, and includes, for example, a device such as a keyboard, a mouse, a track ball, a touch pad, and a touch sensor disposed on the monitor 13 in a superimposed manner.

The display controller 15 performs a predetermined processing on the ultrasound image and the like received from the ultrasound probe 2 under the control of the terminal controller 19, and displays the ultrasound image and the like on the monitor 13.

The monitor 13 displays the ultrasound image and the like received from the ultrasound probe 2 under the control of the display controller 15, and includes, for example, a display device such as a liquid crystal display (LCD) or an organic electroluminescence display (organic EL display).

In the present embodiment, each process in the probe processor 52 and the terminal processor 53 is executed by any computer. In addition, any computer may execute these processes using a processor as hardware, a program as software, or a combination thereof. In such a case, the processor is configured to execute various types of processes in the present embodiment in cooperation with the program, and may function as each unit or each means in the present embodiment. Additionally, the execution order of the process by the processor is not limited to the order described above and may be changed as appropriate. Any computer may be a general-purpose computer, a special-purpose computer, a workstation, or other system capable of executing each process.

The probe processor 52 and the terminal processor 53 may be configured by one or a plurality of pieces of hardware, and the type of the hardware is not limited. For example, the probe processor 52 and the terminal processor 53 may be configured by hardware such as a central processing unit (CPU), a micro processing unit (MPU), a programmable logic device such as a field-programmable gate array (FPGA), a dedicated circuit for executing specific processing such as an application-specific integrated circuit (ASIC), a graphic processing unit (GPU), or a neural processing unit (NPU). Additionally, the type of hardware may be a combination of different types of hardware. In a case where a plurality of hardware components are configured to execute one or a plurality of processes of a certain processor, the plurality of hardware components may be present in devices physically separate from each other or may be present within the same device. In addition, in any embodiment, an order of each process by the probe processor 52 and the terminal processor 53 is not limited to the above-described order, and may be appropriately changed. In addition, hardware is implemented in a form of an electric circuit (circuitry) in which circuit elements, such as semiconductor elements, are combined.

Further, the program may be firmware or software such as a microcode. In addition, the program may be, for example, a program module group, and each function thereof may be implemented by a processor configured to execute each function. The program may be a program code or a plurality of code segments stored in one or a plurality of non-transitory computer-readable media (for example, a storage medium or other storage). The program may be divided and stored in the plurality of non-transitory computer-readable media present in devices physically separate from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

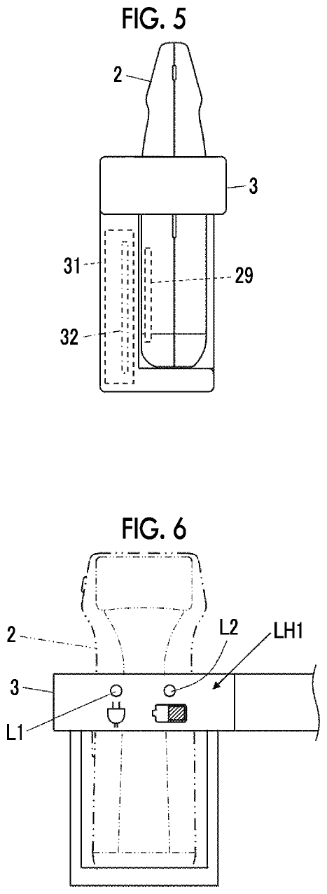

Next, an example of an appearance of the ultrasound system will be described. As shown in FIG. 5, the probe holder 3 that holds the ultrasound probe 2 can hold the ultrasound probe 2, for example, in an erected state. Hereinafter, an example in which the probe holder 3 holds the ultrasound probe 2 in an erected state will be described, but the probe holder 3 may hold the ultrasound probe 2 in any posture, and a method of holding the ultrasound probe 2 is not particularly limited.

The probe holder 3 can incorporate a probe charger 31. The probe charger 31 has a power transmitting coil 32 that emits a magnetic field for supplying power to the ultrasound probe 2, and the power transmitting coil 32 and the power receiving coil 29 of the ultrasound probe 2 are disposed to face each other in a state where the ultrasound probe 2 is held by the probe holder 3. The probe charger 31 is electrically connected to the mobile information terminal 1, and in a case where the ultrasound probe 2 is held by the probe holder 3, power is supplied from the terminal-side battery 11 of the mobile information terminal 1 to the ultrasound probe 2 via the probe charger 31.

As shown in FIG. 6, the probe holder 3 includes a holder light emitting unit (a first light emitting member) LH1, and causes the holder light emitting unit LH1 to emit light according to whether or not the external power supply device 4 (AC adapter) is connected to the mobile information terminal 1 and a remaining amount of the terminal-side battery 11. In the example of FIG. 6, the holder light emitting unit LH1 includes a first light emitting unit L1 indicating the connection of the external power supply device 4 and a second light emitting unit L2 indicating the remaining amount of the terminal-side battery 11.

The first light emitting unit L1 and the second light emitting unit L2 can be configured by, for example, a light emitting diode, and the probe holder 3 can cause the light emitting diode constituting the second light emitting unit L2 to emit light by changing a color according to the remaining amount of the terminal-side battery 11. For example, the probe holder 3 can cause the light emitting diode constituting the second light emitting unit L2 to emit light in a first color such as green in a case where the remaining amount of the terminal-side battery 11 is larger than the remaining amount threshold value, and can cause the light emitting diode constituting the second light emitting unit L2 to emit light in a second color such as orange in a case where the remaining amount of the terminal-side battery 11 is equal to or smaller than the remaining amount threshold value.

In a state where the ultrasound probe 2 is held and the probe-side battery 21 is charged, the probe holder 3 can set the first light emitting unit L1 and the second light emitting unit L2 in a state of being turned on, a state of being turned on and off, or a state of being turned off, for example, as shown in Table 1.

TABLE 1

| | First light emitting unit | | Second light emitting unit | |
|---|---|---|---|---|
| | State | Color | State | Color |
| Battery remaining amount is larger | Turned off | | Turned off | |
| than remaining amount threshold | | | | |
| value | | | | |
| Battery remaining amount is equal | Turned on | Orange | Turned on | Orange |
| to or smaller than remaining amount | and off | | | |
| threshold value | | | | |
| Connected to external power supply | Turned on | Green | Turned off | |

The probe holder 3 can turn off both the first light emitting unit L1 and the second light emitting unit L2 in a case where the remaining amount of the terminal-side battery 11 is larger than the remaining amount threshold value. In addition, in a case where the remaining amount of the terminal-side battery 11 is equal to or smaller than the remaining amount threshold value, the probe holder 3 can turn on and off the first light emitting unit L1 and turn on the second light emitting unit L2, for example, to recommend the connection of the mobile information terminal 1 to the external power supply device 4. In addition, in a case where the mobile information terminal 1 is charged by the external power supply device 4, the probe holder 3 can turn on the first light emitting unit L1 and turn off the second light emitting unit L2. The probe holder 3 can change the light emission colors of the first light emitting unit L1 and the second light emitting unit L2 in a case where the remaining amount of the terminal-side battery 11 is equal to or smaller than the remaining amount threshold value and in a case where the mobile information terminal 1 is charged by the external power supply device 4.

In a state where the ultrasound probe 2 is not held and the probe-side battery 21 is not charged, the probe holder 3 can set the first light emitting unit L1 and the second light emitting unit L2 in a state of being turned on, a state of being turned on and off, or a state of being turned off, for example, as shown in Table 2.

TABLE 2

| | First light emitting unit | | Second light emitting unit | |
|---|---|---|---|---|
| | State | Color | State | Color |
| Battery remaining amount is larger than first | Turned off | | Turned on | Green |
| remaining amount threshold value | | | | |
| Battery remaining amount is equal to or | Turned off | | Turned on | Green |
| smaller than first remaining amount | | | and off | |
| threshold value and is larger than second | | | | |
| remaining amount threshold value | | | | |
| Battery remaining amount is equal to or | Turned off | | Turned on | Orange |
| smaller than second remaining amount | | | and off | |
| threshold value and is larger than third | | | | |
| remaining amount threshold value | | | | |
| Battery remaining amount is equal to or | Turned on | Orange | Turned on | Orange |
| smaller than third remaining amount | and off | | | |
| threshold value and is larger than fourth | | | | |
| remaining amount threshold value | | | | |
| Connected to external power supply | Turned on | Green | Turned off | |

The probe holder 3 can have a plurality of remaining amount threshold values for the remaining amount of the terminal-side battery 11. In the example of Table 2, the probe holder 3 has a first remaining amount threshold value, a second remaining amount threshold value, a third remaining amount threshold value, and a fourth remaining amount threshold value.

The probe holder 3 can turn off the first light emitting unit L1 and turn on the second light emitting unit L2 in a case where the remaining amount of the terminal-side battery 11 is larger than the first remaining amount threshold value. The probe holder 3 can turn off the first light emitting unit L1 and turn on and off the second light emitting unit L2 in a case where the remaining amount of the terminal-side battery 11 is equal to or smaller than the first remaining amount threshold value and is larger than the second remaining amount threshold value. The probe holder 3 can turn off the first light emitting unit L1 and turn on and off the second light emitting unit L2 with a color change in a case where the remaining amount of the terminal-side battery 11 is equal to or smaller than the second remaining amount threshold value and is larger than the third remaining amount threshold value, for example, to indicate that the remaining amount of the terminal-side battery 11 is only for a few more examinations. The probe holder 3 can turn on and off the first light emitting unit L1 and turn on the second light emitting unit L2 in a case where the remaining amount of the terminal-side battery 11 is equal to or smaller than the third remaining amount threshold value and is larger than the fourth remaining amount threshold value, for example, to recommend the connection of the mobile information terminal 1 to the external power supply device 4. In addition, in a case where the mobile information terminal 1 is charged by the external power supply device 4, the probe holder 3 can turn on the first light emitting unit L1 and turn off the second light emitting unit L2.

In a state where the ultrasound probe 2 is not held and the probe-side battery 21 is not charged, the probe holder 3 can also set the first light emitting unit L1 and the second light emitting unit L2 in a state of being turned on, a state of being turned on and off, or a state of being turned off, for example, as shown in Table 3.

TABLE 3

| | First light emitting unit | | Second light emitting unit | |
|---|---|---|---|---|
| | State | Color | State | Color |
| Battery remaining amount is larger than first | Turned off | | Turned on | Green |
| remaining amount threshold value | | | | |
| Battery remaining amount is equal to or | Turned off | | Turned on | Green |
| smaller than first remaining amount | | | and off | |
| threshold value and is larger than second | | | | |
| remaining amount threshold value | | | | |
| Connected to external power supply | Turned on | Green | Turned off | |

In the example of Table 3, the probe holder 3 has the first remaining amount threshold value and the second remaining amount threshold value. The probe holder 3 can turn off the first light emitting unit L1 and turn on the second light emitting unit L2 in a case where the remaining amount of the terminal-side battery 11 is larger than the first remaining amount threshold value, for example, to recommend the connection of the mobile information terminal 1 to the external power supply device 4. The probe holder 3 can turn off the first light emitting unit L1 and turn on and off the second light emitting unit L2 in a case where the remaining amount of the terminal-side battery 11 is equal to or smaller than the first remaining amount threshold value and is larger than the second remaining amount threshold value. In addition, in a case where the mobile information terminal 1 is charged by the external power supply device 4, the probe holder 3 can turn on the first light emitting unit L1 and turn off the second light emitting unit L2.

The probe holder 3 can set the first light emitting unit L1 and the second light emitting unit L2 in a state of being turned on, a state of being turned on and off, or a state of being turned off, for example, as shown in Tables 1 to 3, so that the user can easily ascertain the remaining amount of the terminal-side battery 11.

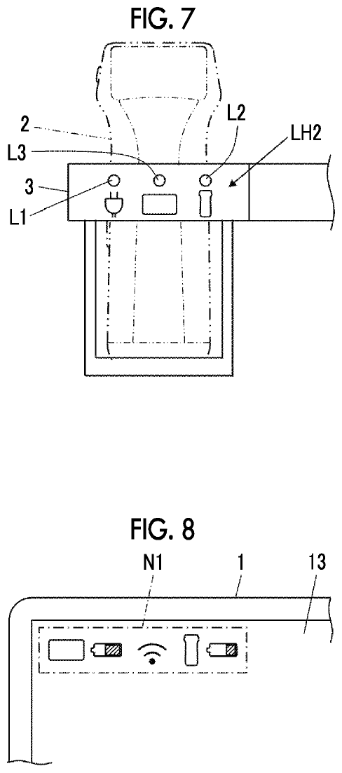

As shown in FIG. 7, the holder light emitting unit LH2 can have the first light emitting unit L1 indicating that the external power supply device 4 is connected to the mobile information terminal 1, the second light emitting unit L2 configured by the light emitting diode for a probe and indicating the remaining amount of the probe-side battery 21, and the third light emitting unit L3 configured by the light emitting diode for a terminal and indicating the remaining amount of the terminal-side battery 11. In this case, the probe holder 3 can change the color of the light emitting diode for a terminal and the light emitting diode for a probe according to the remaining amount of the terminal-side battery 11 and the remaining amount of the probe-side battery 21, for example, to emit light. The probe holder 3 can cause the light emitting diode for a probe constituting the second light emitting unit L2 and the light emitting diode for a terminal constituting the third light emitting unit L3 to emit light in a first color such as green in a case where the remaining amount of the terminal-side battery 11 and the remaining amount of the probe-side battery 21 are larger than the remaining amount threshold value, and can cause the light emitting diode for a probe and the light emitting diode for a terminal to emit light in a second color such as orange in a case where the remaining amount of the terminal-side battery 11 and the remaining amount of the probe-side battery 21 are equal to or smaller than the remaining amount threshold value, for example.

The probe holder 3 can also cause the holder light emitting unit LH1 or LH2 to emit light in a case where the remaining amount of the terminal-side battery 11 is equal to or smaller than a determined threshold value.

The user can easily ascertain at least one of the remaining amount of the terminal-side battery 11 or the remaining amount of the probe-side battery 21 by checking the holder light emitting unit LH1 or LH2.

The mobile information terminal 1 can have preset information on a timing at which the holder light emitting unit LH1 or LH2 emits light in relation to at least one of the examination site of the subject, the type of examination, the information on the subject, or the information on the user. The preset information includes information on a plurality of light emission timings corresponding to each of the examination site of the subject, the type of examination, the information on the subject, and the information on the user, and all combinations thereof. The information on the light emission timing includes information on whether to turn on, turn on and off, or turn off the holder light emitting unit LH1 or LH2, and information on a blinking pattern in a case where the holder light emitting unit LH1 or LH2 is turned on and off. In addition, the examination site of the subject refers to, for example, a site to be examined such as an artery, a heart, or an abdomen. The type of examination includes, for example, an emergency examination, a precise examination, a periodic health checkup, or the like. The information on the subject includes, for example, the age of the subject, information indicating whether the subject is an infant, a young adult, a middle-aged person, or an elderly person, the body type of the subject, an identifier (ID) of the subject, or the like. The information on the user includes, for example, the ID of the user, a medical department to which the user belongs, a facility such as a hospital to which the user belongs, or the like. The examination site of the subject, the type of examination, the information on the subject, and the information on the user are input by the user via, for example, the input device 20 of the mobile information terminal 1.

In this case, the mobile information terminal 1 can determine the timing at which the holder light emitting unit LH1 or LH2 emits light, based on the preset information. The user can ascertain the examination site of the subject, the type of examination, the information on the subject, or the like by checking the light emission timing of the holder light emitting unit LH1 or LH2.

In addition, the mobile information terminal 1 can display both the remaining amount of the terminal-side battery 11 and the remaining amount of the probe-side battery 21 on the monitor 13, for example, by displaying the notification NI on the monitor 13 as shown in FIG. 8, at any of the end of the examination, the start of the examination, or the recovery from sleep, or at each of the end of the examination, the start of the examination, and the recovery from sleep. The user can easily check both the remaining amount of the terminal-side battery 11 and the remaining amount of the probe-side battery 21 by checking the notification N1 displayed on the monitor 13.

The mobile information terminal 1 can further display the wireless communication state between the mobile information terminal 1 and the ultrasound probe 2 on the monitor 13, in addition to the remaining amount of the terminal-side battery 11 and the remaining amount of the probe-side battery 21. The wireless communication state between the mobile information terminal 1 and the ultrasound probe 2 refers to the radio wave intensity of the wireless communication between the mobile information terminal 1 and the ultrasound probe 2.

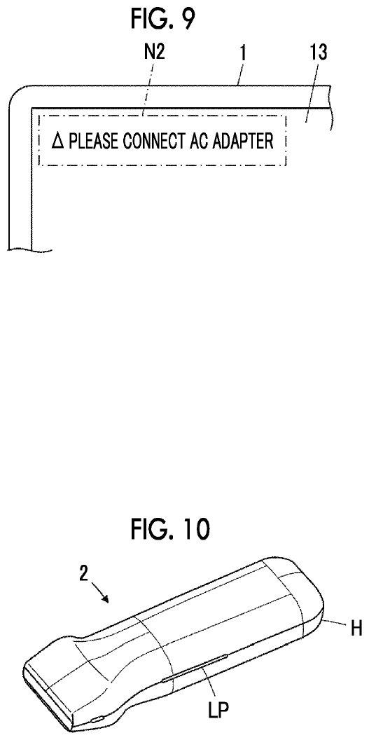

In addition, the mobile information terminal 1 can notify the user in a case where the remaining amount of the terminal-side battery 11 is equal to or less than a determined threshold value, for example, by displaying the notification N2 on the monitor 13 as shown in FIG. 9. In the example of FIG. 9, the notification N2 of “please connect AC adapter” is displayed on the monitor 13. For example, in a case where the mobile information terminal 1 comprises a speaker (not shown), the mobile information terminal 1 can also notify the user by a sound via the speaker. The user can easily ascertain that the remaining amount of the terminal-side battery 11 is small by checking the notification from the mobile information terminal 1, and can take measures such as charging the terminal-side battery 11 before starting the examination of the subject.

In a case of notifying the user by displaying the notification N2 or the like on the monitor 13, the mobile information terminal 1 can set the display size of the notification on the monitor 13 during the examination larger than the display size of the notification on the monitor 13 during the examination stop. The examination refers to a state where the ultrasound probe 2 transmits and receives ultrasound waves to and from the subject, and a so-called live display in which the ultrasound images generated by the transmission and reception of the ultrasound waves are sequentially displayed on the monitor 13 is performed on the monitor 13. The examination stop is a state where the live display of the ultrasound image U is not performed on the monitor 13, and can include, for example, a freeze of the ultrasound image, the end of the examination, the start of the examination, and the recovery from sleep of the mobile information terminal 1. By setting the display size of the notification on the monitor 13 during the examination larger than the display size of the notification on the monitor 13 during the examination stop, the user can clearly check the notification such as the notification N2 even in a state where the user is paying attention to the examination of the subject.

In addition, the mobile information terminal 1 can have preset information on a timing of notifying the user in relation to at least one of the examination site of the subject, the type of the examination, the information on the subject, or the information on the user. The preset information includes information on a plurality of notification timings corresponding to each of the examination site of the subject, the type of the examination, the information on the subject, and the information on the user, and all combinations thereof. The examination site of the subject refers to, for example, a site to be examined such as an artery, a heart, or an abdomen.

The type of examination includes, for example, an emergency examination, a precise examination, a periodic health checkup, or the like. The information on the subject includes, for example, the age of the subject, information indicating whether the subject is an infant, a young adult, a middle-aged person, or an elderly person, the body type of the subject, an ID of the subject, or the like. The information on the user includes, for example, the ID of the user, a medical department to which the user belongs, a facility such as a hospital to which the user belongs, or the like. The examination site of the subject, the type of examination, the information on the subject, and the information on the user are input by the user via, for example, the input device 20 of the mobile information terminal 1.

In this case, the mobile information terminal 1 can determine the timing of notifying the user, based on the preset information. The user can ascertain the examination site of the subject, the type of the examination, the information on the subject, or the like by checking the timing of the notification.

In addition, for example, as shown in FIG. 10, the ultrasound probe 2 can have a probe light emitting unit (a second light emitting member) LP. In the example of FIG. 10, the probe light emitting unit LP is disposed on a side surface portion of the housing H of the ultrasound probe 2. For example, in a case where the ultrasound probe 2 is held by the probe holder 3, the probe holder 3 can stop the light emission by the holder light emitting unit LH1 or LH2 and can cause the probe light emitting unit LP to emit light. As a result, the user can easily ascertain that the probe-side battery 21 is in a state of being charged by the probe charger 31 of the probe holder 3.

Although an example in which the probe charger 31 wirelessly charges the probe-side battery 21 has been described, the probe charger 31 can also charge the probe-side battery 21 in a wired manner. A method of charging performed by the probe-side battery 21 is not particularly limited.

In addition, a form of the wireless communication between the mobile information terminal 1 and the ultrasound probe 2 is not particularly limited, and, for example, so-called Wi-Fi (registered trademark), so-called Bluetooth (registered trademark), or so-called mobile communication can be used as the form of the wireless communication.

### Embodiment 2

Although it has been described that the charging controller 12 charges the probe-side battery 21 by the probe charger 31 based on the drivable period of the mobile information terminal 1 and the drivable period of the ultrasound probe 2, a control method of charging the probe-side battery 21 by the charging controller 12 is not limited thereto.

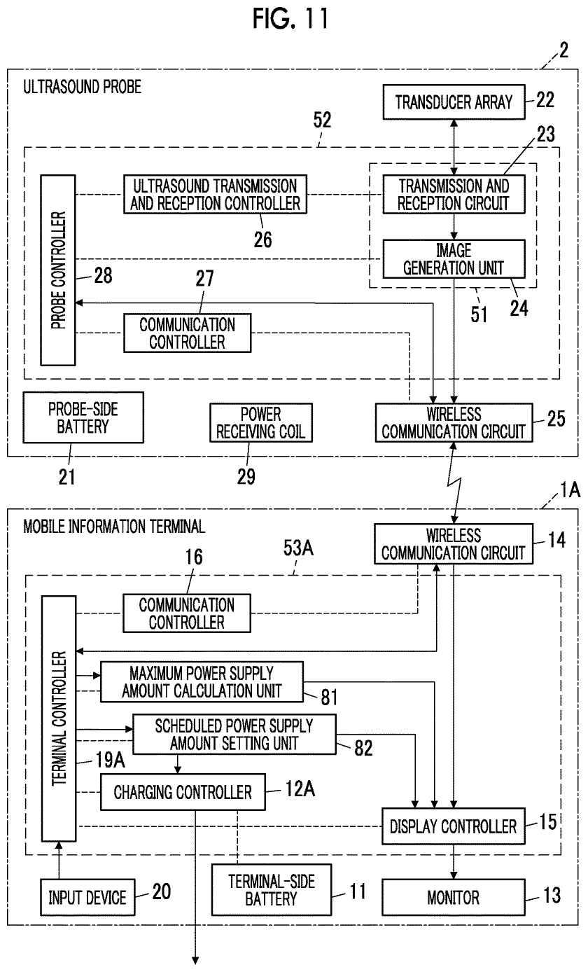

FIG. 11 shows a configuration of a mobile information terminal 1A and the ultrasound probe 2 in Embodiment 2. The ultrasound probe 2 is the same as the ultrasound probe 2 in Embodiment 1 shown in FIG. 2. The mobile information terminal 1A comprises a maximum power supply amount calculation unit 81 and a scheduled power supply amount setting unit 82 instead of the terminal-side period calculation unit 17 and the probe-side period calculation unit 18, comprises a charging controller 12A instead of the charging controller 12, and comprises a terminal controller 19A instead of the terminal controller 19, in the mobile information terminal 1 in Embodiment 1 shown in FIG. 2.

In the mobile information terminal 1A, the maximum power supply amount calculation unit 81 is connected to the terminal controller 19A. The scheduled power supply amount setting unit 82 is connected to the maximum power supply amount calculation unit 81 and the terminal controller 19A. The scheduled power supply amount setting unit 82 is connected to the charging controller 12A. In addition, the maximum power supply amount calculation unit 81 and the scheduled power supply amount setting unit 82 are connected to the display controller 15. In addition, a processor 53A for the mobile information terminal 1A is configured by the charging controller 12A, the display controller 15, the communication controller 16, the terminal controller 19A, the maximum power supply amount calculation unit 81, and the scheduled power supply amount setting unit 82.

The maximum power supply amount calculation unit 81 calculates the maximum power supply amount to be supplied from the terminal-side battery 11 to the probe-side battery 21 based on the remaining amount of the terminal-side battery 11. The maximum power supply amount calculation unit 81 can calculate, as the maximum power supply amount, for example, the maximum time for which the power can be supplied from the terminal-side battery 11 to the probe-side battery 21, the maximum number of examinations that can be performed by the power that can be supplied from the terminal-side battery 11 to the probe-side battery 21, or the like. The maximum power supply amount calculation unit 81 can calculate, for example, the maximum time for which the power can be supplied by storing in advance the average supply power to be supplied from the terminal-side battery 11 to the probe-side battery 21 per determined time, and dividing the remaining amount of the terminal-side battery 11 by the average supply power. In addition, the maximum power supply amount calculation unit 81 can calculate, for example, the maximum number of examinations by storing in advance the reference value of the power consumed by the ultrasound probe 2 in one examination, and dividing the remaining amount of the terminal-side battery 11 by the reference value of the power consumption by the ultrasound probe 2 per one examination.

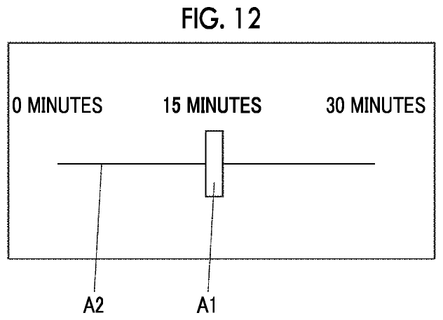

The scheduled power supply amount setting unit 82 sets the scheduled power supply amount to be supplied from the terminal-side battery 11 to the probe-side battery 21 in a range up to the maximum power supply amount calculated by the maximum power supply amount calculation unit 81. The scheduled power supply amount setting unit 82 can set, for example, a value input by the user via the input device 20 of the mobile information terminal 1A as the scheduled power supply amount. In this case, the display controller 15 can display, for example, a slider A1 and a slider bar A2 as shown in FIG. 12. The left end of the slider bar A2 represents the minimum time for which the power can be supplied, and the right end represents the maximum time for which the power can be supplied. In the example of FIG. 12, the minimum time for which the power can be supplied is 0 minutes, and the maximum time for which the power can be supplied is 30 minutes. The user can set the scheduled power supply amount, for example, by moving the slider A1 along the slider bar A2 via the input device 20. In the example of FIG. 12, the scheduled power supply amount is set to 15 minutes.

The charging controller 12A performs charging of the probe-side battery 21 by the probe charger 31 until the power supply amount is equal to or greater than the scheduled power supply amount set by the scheduled power supply amount setting unit 82. By appropriately setting the scheduled power supply amount by the user, the ultrasound system can efficiently use the probe-side battery 21 and the terminal-side battery 11 such that the drivable periods of the ultrasound probe 2 and the mobile information terminal 1A are substantially the same.

### EXPLANATION OF REFERENCES

1, 1A: mobile information terminal
2: ultrasound probe
3: probe holder
4: external power supply device
11: terminal-side battery
12, 12A: charging controller
13: monitor
14: wireless communication circuit
15: display controller
16: communication controller
17: terminal-side period calculation unit
18: probe-side period calculation unit
19, 19A: terminal controller
20: input device
21: probe-side battery
22: transducer array
23: transmission and reception circuit
24: image generation unit
25: wireless communication circuit
26: ultrasound transmission and reception controller
27: communication controller
28: probe controller
29: power receiving coil
31: probe charger
32: power transmitting coil
51: image acquisition unit
52: probe processor
53, 53A: terminal processor
71: pulser
72: amplification unit
73: AD conversion unit
74: beam former
75: signal processing unit
76: DSC
77: image processing unit
81: maximum power supply amount calculation unit
82: scheduled power supply amount setting unit
A1: slider
A2: slider bar
C: AC power supply
L1: first light emitting unit
L2: second light emitting unit
L3: third light emitting unit
LH1, LH2: holder light emitting unit
LP: probe light emitting unit
N1, N2: notification

What is claimed is:

1. An ultrasound system comprising:
a mobile information terminal that includes a monitor and incorporates a terminal-side battery;
an ultrasound probe that is connected to the mobile information terminal and that incorporates a probe-side battery; and
a probe charger that charges the probe-side battery with power supplied from the terminal-side battery,
wherein the mobile information terminal includes a processor configured to control the charging of the probe-side battery by the probe charger based on a remaining amount of the terminal-side battery.

2. The ultrasound system according to claim 1,
wherein the processor is configured to:
calculate a drivable period of the mobile information terminal by the terminal-side battery based on the remaining amount of the terminal-side battery;
calculate a drivable period of the ultrasound probe by the probe-side battery based on a remaining amount of the probe-side battery; and
perform the charging of the probe-side battery by the probe charger until a difference between the drivable period of the mobile information terminal and the drivable period of the ultrasound probe is equal to or less than a determined threshold value.

3. The ultrasound system according to claim 1,
wherein the processor is configured to:
calculate a maximum power supply amount to be supplied from the terminal-side battery to the probe-side battery, based on the remaining amount of the terminal-side battery;
set a scheduled power supply amount to be supplied from the terminal-side battery to the probe-side battery in a range up to the maximum power supply amount; and
perform the charging of the probe-side battery by the probe charger until the power supply amount is equal to or greater than the scheduled power supply amount.

4. The ultrasound system according to claim 1, further comprising:
a probe holder that holds the ultrasound probe and in which the probe charger is disposed.

5. The ultrasound system according to claim 2, further comprising:
a probe holder that holds the ultrasound probe and in which the probe charger is disposed.

6. The ultrasound system according to claim 3, further comprising:
a probe holder that holds the ultrasound probe and in which the probe charger is disposed.

7. The ultrasound system according to claim 4,
wherein the probe holder includes a first light emitting member, and is configured to cause the first light emitting member to emit light according to at least one of the remaining amount of the terminal-side battery or a remaining amount of the probe-side battery.

8. The ultrasound system according to claim 7,
wherein the first light emitting member is composed of a light emitting diode, and causes the light emitting diode to emit light by changing a color according to at least one of the remaining amount of the terminal-side battery or the remaining amount of the probe-side battery.

9. The ultrasound system according to claim 7,
wherein the first light emitting member is composed of a light emitting diode for a terminal and a light emitting diode for a probe, and
the probe holder causes the light emitting diode for a terminal and the light emitting diode for a probe to emit light by changing a color according to the remaining amount of the terminal-side battery and the remaining amount of the probe-side battery.

10. The ultrasound system according to claim 7,
wherein the probe holder is configured to cause the first light emitting member to emit light in a case where the remaining amount of the terminal-side battery is equal to or less than a determined threshold value.

11. The ultrasound system according to claim 10,
wherein the mobile information terminal
includes preset information related to at least one of an examination site of a subject, a type of an examination, information on the subject, or information on a user, and
is configured to determine a timing at which the first light emitting member emits light, based on the preset information.

12. The ultrasound system according to claim 1,
wherein the mobile information terminal notifies a user in a case where the remaining amount of the terminal-side battery is equal to or less than a determined threshold value.

13. The ultrasound system according to claim 12,
wherein the mobile information terminal
notifies the user by displaying on the monitor, and
sets a display size of the notification on the monitor during an examination to be larger than a display size of the notification on the monitor during an examination stop.

14. The ultrasound system according to claim 12,
wherein the mobile information terminal
includes preset information related to at least one of an examination site of a subject, a type of an examination, information on the subject, or information on the user, and
determines a timing of notifying the user, based on the preset information.

15. The ultrasound system according to claim 1,
wherein the mobile information terminal displays, on the monitor, both the remaining amount of the terminal-side battery and a remaining amount of the probe-side battery.

16. The ultrasound system according to claim 15,
wherein the mobile information terminal further displays, on the monitor, a wireless connection state between the ultrasound probe and the mobile information terminal.

17. The ultrasound system according to claim 15,
wherein the mobile information terminal displays, on the monitor, both the remaining amount of the terminal-side battery and the remaining amount of the probe-side battery at any of an end of an examination, a start of the examination, or recovery from sleep.

18. The ultrasound system according to claim 15,
wherein the mobile information terminal displays, on the monitor, both the remaining amount of the terminal-side battery and the remaining amount of the probe-side battery at each of an end of an examination, a start of the examination, and recovery from sleep.

19. The ultrasound system according to claim 7,
wherein the ultrasound probe includes a second light emitting member, and
while the ultrasound probe is held by the probe holder, the probe holder is configured to stop the light emission by the first light emitting member and cause the second light emitting member to emit light.

20. A control method of an ultrasound system including a mobile information terminal that incorporates a terminal-side battery, an ultrasound probe that incorporates a probe-side battery, and a probe charger that charges the probe-side battery with power supplied from the terminal-side battery, the control method comprising:
controlling the charging of the probe-side battery by the probe charger based on a remaining amount of the terminal-side battery.
